(19) United States
(12) Patent Application Publication
(10) Pub. No.: US 2007/0077397 A1
(43) Pub. Date: Apr. 5, 2007

(54) Bonding intermediate, method and machine for bonding coated textile sheets

(75) Inventor: Carlos Saiz, Chambery (FR)

Correspondence Address: BURR & BROWN, PO BOX 7068, SYRACUSE, NY, 13261-7068, US

(73) Assignee: Tissage Et Enduction Serge Ferrari SA, Saint Jean De Soudain (FR)

(21) Appl. No.: 11/541,923

(22) Filed: Oct. 2, 2006

Related U.S. Application Data
(63) Continuation of application No. PCT/FR05/50202, filed on Mar. 30, 2005.

(30) Foreign Application Priority Data
Apr. 20, 2004 (FR) 04.04156

(51) Int. Cl. B32B 3/00

(52) U.S. Cl. 428/172; 428/167

(57) ABSTRACT

Bonding intermediate for coated textile sheets with a silicone based polymer coating, having the form of a strip including a non-cross-linked silicone elastomer fraction present on at least the external sides of the said strip. According to the invention, the bonding intermediate includes heat energy dissipating elements embedded in the non-cross-linked silicon elastomer mass.

### TECHNICAL FIELD

The invention belongs to the field of technical textiles, and more particularly of coated or lined textiles. It relates more specifically to coated textiles comprising at least one silicone based coat. The invention relates more particularly to the means and a method for assembling various silicone based coated textiles.

### PRIOR ART

In general, textiles coated with a coating based on silicone polymers are known for their excellent temperature resistance, particularly their fire resistance and their property of resistance to chemical attack and ultraviolet radiation. This type of textile is therefore frequently used in problematic temperature conditions. For this purpose, the textile core may advantageously, but not exclusively, be made on the basis of glass yarn, known for its good thermal properties.

A problem generally arises when joining various pieces of coated fabric, particularly for making large width products.

Thus, stitching techniques have been widely employed, but they have certain drawbacks. In fact, stitching operations generate holes which are sources of subsequent incipient tearing. Moreover, the stitches do not form a sealed barrier.

Furthermore, stitching operations are relatively problematic because of the need to overcome the friction of the stitching yarn with the silicone polymer material of the coating layer that opposes the sliding of the stitching yarn. This explains the frequent use of polytetrafluoroethylene based yarn known for its low friction coefficient. However, this yarn, although having good tensile strength, is relatively costly.

Among the other drawbacks of stitching, mention can be made of the fact that the passage of the needle through the textile fabric breaks a number of threads, thereby decreasing the mechanical strength thereof. Moreover, the holes generated by the stitching yarn constitute moisture entry points, which can cause deterioration of the mechanical properties of the glass yarn, and hence of the fabric in general.

Other joining techniques are also employed, consisting in the use of a liquid bonding method. Such a method consists in depositing a surface treatment on the silicone coated fabric, for chemically activating the surface. In a second step, a liquid adhesive is deposited, and the fabrics are joined together by pressing.

However, the conditions in which this bonding must take place are relatively restrictive, because the application of the surface treatment, followed by the liquid adhesive, must be carried out in a dust-free atmosphere. Moreover, the surface treatment and the liquid adhesive generally create smudges which harm the visual appearance of the bonding zone. Furthermore, the pressing must be relatively long to ensure effective bonding. Besides, the surface treatment and the liquid adhesive cannot be applied to openwork coated fabrics, for example obtained using a mesh or woven coated yarn. The surface treatment and the liquid adhesive are in fact useless in this case, because they collect in the openings of the fabric. The contact surfaces between the two textiles are therefore uncontrolled.

Bonding methods are also known using a silicone strip inserted between two surfaces to be joined together. As described in documents EP 0,219,075 and EP 0,214,631, bonding can be achieved by placing, between two sheets, at their superimposition zones, an element forming an adhesive tape on both its sides. This adhesive tape is partly essentially formed of non-cross-linked silicone elastomer, so that when subjected to sufficient pressure and temperature, during a predefined period, this non-cross-linked silicone elastomer reacts with the silicone of the coating layers of the sheets to be joined to cause the creation of chemical bonds thereby forming the bonding base.

In this case, heating initiates a cross-linking reaction of the non-cross-linked silicone, which is inserted under pressure between the two surfaces to be joined. The heat energy liberated causes the cross-linking of the non-cross-linked silicone, which then combines with the silicone of the surface or surfaces of the coated fabrics. This silicone cross-linking reaction thereby enables the coating layers of the coated sheets to adhere together. This cross-linking reaction is therefore obtained using an external energy source.

However, such a cross-linking reaction is very slow and it is consequently necessary to heat the same zone for a period of several tens of seconds. Such a method is therefore incompatible with the production rates associated with the coated textile manufacture and garment industry.

It is accordingly one object of the invention to propose a method for bonding silicone coated fabric which is easy to implement, and permits rapid and controlled industrial production while eliminating all the abovementioned drawbacks.

### SUMMARY OF THE INVENTION

The invention hence relates to a bonding intermediate for coated textile sheets with a silicone based polymer coating. This intermediate has the form of a strip that includes a non-cross-linked silicone elastomer fraction which is present on at least the outer sides of this strip.

According to the invention and in order to significantly improve the kinematics of the cross-linking reaction, the characteristic strip includes heat energy dissipating elements embedded in the non-cross-linked silicone mass, and carefully distributed therein. In this case, the external activation means serve to radiate an energy which is absorbed by these dissipating elements, and then diffused in the very core of the characteristic strip, thereby improving the cross-linking mechanisms.

Advantageously in practice, these heat energy dissipating elements can be selected to absorb the radiation in the infrared spectrum, and more precisely in the band from 800 to 1200 nanometres.

In practice, various arrangements can be adopted to facilitate the handling of the characteristic adhesive strip. Thus, the strip may comprise a plurality of longitudinal reinforcing elements conferring strength and limiting the elongation capacity. These reinforcing elements may be formed from textile yarn embedded in the non-cross-linked silicone mass. This textile yarn may also be associated by weaving with other yarn in the crosswise direction. This textile yarn may advantageously be selected to have a radiation absorption capacity designed to raise the temperature of the non-cross-linked silicone.

According to an alternative solution, the strip may comprise a mesh in the mass formed of material cross-linked by infrared radiation, this cross-linked material forming a network capable of ensuring the mechanical strength of the strip. In other words, the characteristic strip may include previously cross-linked zones which are therefore less deformable, and therefore capable of withstanding the tension during the laying operations. These cross-linked zones form reinforcing elements consisting of the same material as the rest of the strip, as opposed to the embodiments in which elements of different types are embedded in the non-cross-linked silicone.

According to another aspect of the invention, the strip forming the bonding intermediate may also have a plurality of parallel longitudinal grooves. These grooves confer many advantages on the bonding strip. In fact, they represent longitudinal cutting zones of the strip, serving to adapt the strip to the width of the desired bonding zone.

Furthermore, and above all, these grooves constitute visual markers facilitating the relative positioning of the bonding strip with respect to the fabric selvedge.

In fact, it is thereby possible to set up the fabric on the bonding strip with an alignment accuracy of about the width between two grooves. This accuracy serves to limit the risks of smudging by spreading of the non-cross-linked silicone during the actual bonding operation.

According to another aspect of the invention, this bonding can be implemented on a particular assembly machine.

This machine mainly comprises an assembly table suitable for receiving the two textiles sheets to be joined at a zone of superimposition of their edges. This machine also comprises a heating and pressing member, a source of infrared radiation.

According to the invention, this heating and pressing member comprises a photoelectrode or emitter, capable of emitting radiation in the infrared spectrum. This pressing and heating member also comprises a pressing element, transparent to the radiation of the infrared spectrum. This pressing element has one side coming into contact with the zone of superimposition of the two edges of the sheets to be bonded by applying pressure. In other words, the machine comprises an energy source emitting radiation through the pressing element without the latter absorbing a significant fraction of this energy, and hence transmitting it to the textile sheets and to the non-cross-linked silicone strip while applying a sufficient pressure.

Very preferably, the material used to form the pressing element may be of quartz which has a very good infrared radiation transmission coefficient in the spectrum concerned.

The raising of the temperature of the non-cross-linked (or raw) silicone located between the two sheets, and of the silicone of the coating layer, is effected in a combined manner, on the one hand by the infrared radiation, and on the other by conduction at the contact between the outer face of the pressing element and the coated textile. The quartz pressing element is maintained at a minimum or “thermal standby” temperature, of about 200° C. by the pulsed activation of the IR radiation source. The slight absorption of the quartz in the IR frequency band concerned suffices to maintain this minimum temperature.

Various architectures can be employed to obtain the desired heating. Thus, the machine may comprise two heating and pressing members, placed on either side of the zone of superimposition of the edges of the sheet. These two pressing elements each ensure the heating of the bonding zone by one of the sides of the assembly, thereby improving the speed and uniformity of the temperature rise.

An alternative solution consists in using a machine which comprises a single heating and pressing element, and which further comprises a device reflecting the infrared radiation, which is positioned opposite the heating and pressing member, beyond the two sheets to be bonded.

In other words, the machine comprises a single heating member which emits the characteristic radiation on one side of the bonding zone. The unabsorbed fraction of the radiation is reflected on a mirror element located on the other side of the textile sheet. This reflected fraction contributes to the heating of the various silicone materials, and hence the bonding efficiency.

In practice, the heating and pressing member has a longitudinal shape that extends parallel to the zone of superimposition of the edges of the two sheets, in order to ensure the bonding on sufficiently long portions to obtain a high production rate.

To facilitate handling operations, it may be preferable for the heating and pressing member to be mobile with respect to the table, so that it moves relative to this table, and hence relative to the textile sheets to be joined. This avoids movements of the textile which are the source of alignment defects in particular.

According to another aspect of the invention, the heating and pressing element may match a particular shape designed to improve the bonding efficiency and the uniformity of its visual appearance. Thus, the pressing element may have a longitudinal offset on its side opposite the sheets to be bonded, defining two substantially parallel and offset plane zones.

In other words, the pressing element comes into contact with the textile sheets to be bonded in distinct zones. A first zone comes into contact with the assembly, at the level where the two sheets are superimposed and imprison the bonding strip of non-cross-linked silicone. The pressing element also comes into contact with the zone of lower thickness comprising a single layer of textile sheet at the edge of the bonding zone.

In this way, the characteristic pressure is not only applied to the actual bonding zone, but also in the immediately adjacent zones, thereby preventing an excessive spreading of the non-cross-linked silicone which could create smudges.

The non-cross-linked silicone is thereby confined in the bonding zone in which it fills the space between the two textile sheets and particularly the edges of the selvedges of the textile sheets, thereby improving the tightness thereof, and hence preventing the penetration of moisture into the textile core.

### BRIEF DESCRIPTION OF THE FIGURES

The implementation of the invention, and the resulting advantages, clearly appear from the description of the embodiment that follows, with reference to the figures appended hereto in which:

FIG. 1 is a brief perspective view of a bonding intermediate forming a strip according to the invention.

FIG. 2 is a schematic view of a machine according to the invention.

FIG. 3 shows a cross section of the heating and pressing member according to the invention.

FIGS. 4 and 5 show schematic cross sections of the bonding zone shown respectively before and after the action of the pressing and heating member.

FIGS. 6 and 7 show exemplary embodiments of the strip, of which part of the raw silicone material is cross-linked to form a network and to serve for mechanical strength.

### IMPLEMENTING THE INVENTION

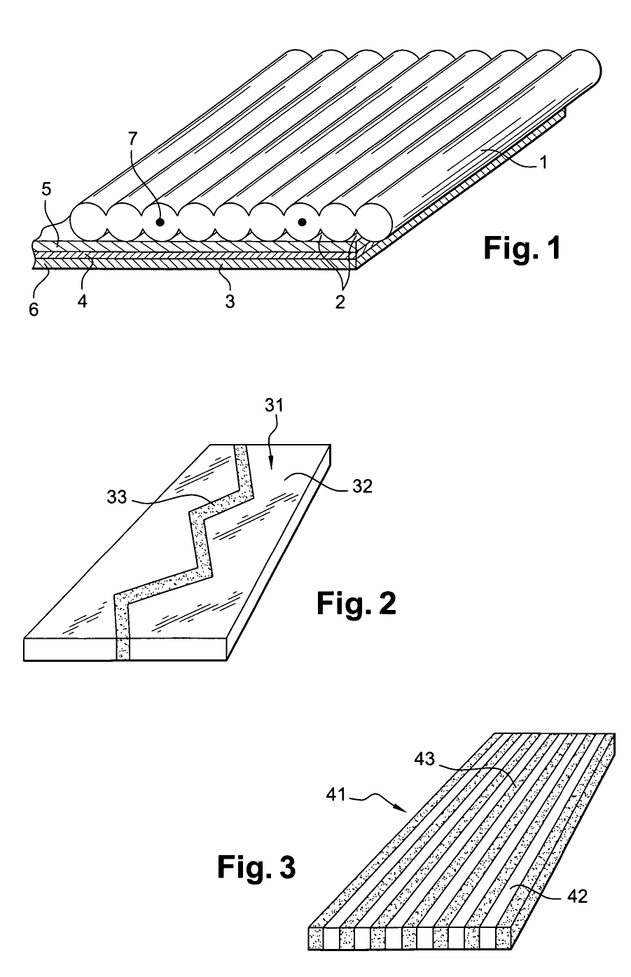

FIG. 1 shows a bonding strip (1) according to the invention which can be made by extrusion, in order to have the characteristic profile defining a plurality of grooves (2). These various grooves (2) permit, as already stated, the longitudinal separation of the strip (1) into several strips of smaller width. Above all, it permits the positioning of this strip (1) with great accuracy with respect to the coated textile sheet (3) which it is intended to bond.

More precisely, and as shown in FIG. 1, the first groove (2) can be aligned with the edges of the coated textile sheet (3) using the visual marker constituted by the groove (2).

The coated textile sheet (3) shown in FIG. 1 has a textile core (4) which may be of various types, and particularly based on polyester or glass fibres. This textile core may be of the woven, knitted or non-woven type. This textile core (3) is associated with a coating layer (5) based on silicone polymer. It may be observed that for the invention to be implemented, it is sufficient for the two sides facing the coated textile (3) to be bonded to be silicone based, thereby making it possible to employ hybrid textiles having two coating layers (5, 6) of different types.

The main material constituting the characteristic strip (1) is based on non-cross-linked silicone elastomer. Numerous materials may be used, with different formulations and compositions according to the type of sheet (3) to be bonded. In a particular exemplary embodiment, good results have been obtained using a hot-vulcanizable silicone elastomer composition as non-cross-linked silicone. These compositions are known to generally consist of high molecular weight polydimethylsiloxanes, combined with reinforcing mineral fillers and various additives for hardening them by cross-linking of the polymer chains, and even promoting their anchoring to the supports to which they are apposed. These materials are in a form that is consistent but deformable under stress; they are also hot-vulcanizable to form a material of rubbery appearance with mechanical strength. Their shaping requires pressures of tens of bar, and their vulcanization typically occurs in a few minutes at temperatures of about 100 to 180° C.

Another example of compositions suitable for use for bonding belongs to the “Liquid Silicone Rubber” family. The advantage of these compositions is a greater fluidity which can facilitate the processing. These compositions are known to be prepared with lower molecular weight polymers than the previous family. They can also be combined with ingredients for vulcanization and, optionally, to promote the bonding. They also vulcanize in a few minutes at high temperature.

This non-cross-linked silicone strip (1), as shown in FIG. 1, may include longitudinal reinforcing yarn (7) permitting its handling, while limiting its stretching capacity. The non-cross-linked silicone is in the form of a very highly deformable material, and the slightly extensible reinforcing yarn (7) limits this deformability.

Other reinforcing elements can be employed, such as woven textile structures, optionally meshes, or optionally, non-woven structures.

In exemplary embodiments, this non-cross-linked silicone strip may include, as shown in FIGS. 2 and 3, meshes cross-linked by short IR radiation and of which the geometry is determined according to the advantage desired in terms of better mechanical strength, limited flow during pressing, and plugging of the end of the textile sheet edges.

Thus, as shown in FIG. 2, the strip (31) comprises a previously cross-linked zone (33), extending along the strip and winding on its width, through the main zone of non-cross-linked silicone (32). According to the exemplary embodiment shown in FIG. 3, the strip (41) includes several previously cross-linked parallel strips (43), separating the silicone strips (42) intended to be cross-linked during the bonding. Obviously, during prior cross-linking operations to form these mechanical reinforcements, all sorts of geometries can be defined, by negative or positive photo-cross-linking.

The characteristic strip (1) advantageously contains heat energy dissipating elements. These elements may consist of a powder of fine particles embedded in the non-cross-linked silicone material. Numerous powders may be selected, insofar as they have chemical behaviour not detrimental to the properties of the non-cross-linked silicone, and they absorb the radiation in the infrared spectrum.

Among many examples which have given satisfaction, mention can be made of a pigment powder based on tin and antimony oxide, such as, for example, MINATEC 230 A IR sold by Merck.

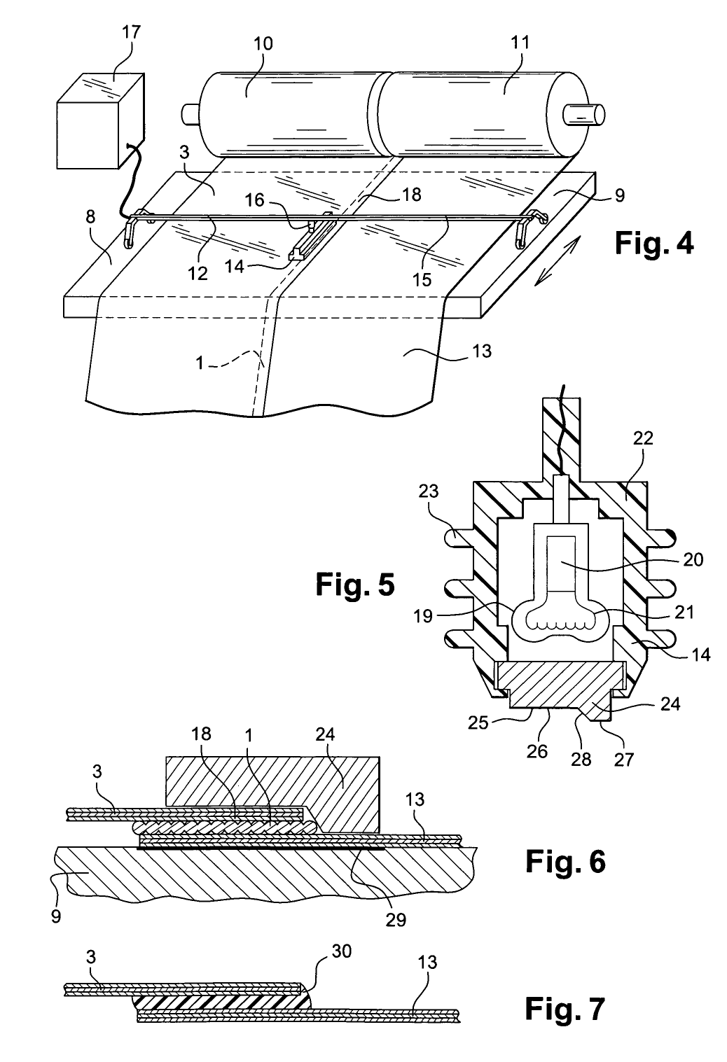

The characteristic strip (1) is therefore employed as shown in FIG. 4 on a machine (8) for assembly by bonding. This machine (8) mainly comprises a table (9) on which the two sheets (3, 13) of textile to be joined can be placed. These two sheets (3, 13) may, for example, be unwound from rolls (10, 11) for virtually continuous production. These two sheets (3, 13) are hence placed on the table so that they have an overlapping zone, imprisoning the characteristic strip (1) of non-cross-linked silicone.

This table (9) is associated with a device (12) for moving the pressing and heating member (14). Various architectures may be employed, including those shown schematically, consisting in moving the pressing and heating member (14) by a crane (15) travelling longitudinally, parallel to the bonding zone (18).

In its central part, this device (12) comprises the pressing and heating member (14), which is able to move vertically via an electric cylinder (16) for example, or in general, by any devices for generating a vertical movement.

This pressing and heating member (14) is powered electrically by a device (17) shown schematically on the side of a machine (8) and including appropriate monitoring-control means.

Obviously, the machine (8) may include several heating and pressing elements (14) acting simultaneously, and arranged on all or part of the length of the bonding zone (18).

More precisely, and as shown in FIG. 5, the heating and pressing element (14) is mainly composed of an electrically powered emitter or photo-electrode (20), comprising one or more incandescent filaments (21). These filaments (21) are selected from a material permitting emission in the infrared spectrum, and generally between 800 and 1200 nanometres. Excellent results have been obtained using “short wave/fast IR-twin-tube emitters” produced by Heraeus Noblelight, in combination with quartzes manufactured by the same company under reference HOQ 310.

These emitters (20) have the following specific characteristics:
power density 200 W/cm,
cross section 23×11 mm,
filament temperature 2400 K to 3200 K, which, according to Planck's law, corresponds to wavelengths of which the peaks are centred respectively on 1200 nanometres and 900 nanometres,
gold semi-hemispherical reflectors.

The emitters (20) consist of a quartz bulb (19) and two filaments (21). These filaments may either be identical and hence simultaneously emit in the same frequencies if controlled by the same signal, or emit simultaneously in different frequencies if controlled by different signals, or be different and emit in different frequencies when controlled by an identical signal.

This feature procures numerous advantages compared to the system developed above for assembling silicones. The HOQ 310 quartz has a transmission passband of 95% ranging from 280 nanometres to 2000 nanometres, which is very favourable in the 800 nanometres to 1200 nanometres band used for baking non-cross-linked or raw silicone.

To maintain the quartz at a “standby” temperature of 200° C., it suffices to under-power the filaments (21) to emit at 4000 nanometres. In this way, the HOQ 310 quartz has a transmission of only 10% and an absorption of 90% at this wavelength. This quartz heating function may be assigned to one of the filaments of the emitter during the active bonding phase, while the second filament of the emitter is specialised in the production of 800 nm to 1200 nm signals which pass through the HOQ 310 quartz without attenuation, causing very rapid baking of the raw silicone.

This emitter (20) has the advantage of not having thermal inertia (less than one second), and permitting virtually immediate radiation of its electric power supply. This emitter (20) is maintained in a frame (22) formed from a section comprising fins (23) for dissipating heat energy. This frame (22) is associated with the cylinder (16) for its vertical movement.

In its lower part, the section (22) encases the pressing element (24) made of quartz. This quartz has an excellent radiation transmission coefficient in the infrared spectrum and can accommodate temperature gradients of several hundred degrees. The maximum working temperature can reach 1300° C., the thermal expansion coefficient being 5.9×10⁻⁷ per K at 300° C.

As already stated, good results have been obtained with quartzes manufactured by Heraeus Noblelight under reference HOQ 310. However, other equivalent materials could serve to obtain similar results.

The lower side (25) of the quartz element, intended to come into contact with the textile, has a particular surface texture resulting from an annealing operation. The surface texture thereby obtained is particularly bright and smooth, in order to avoid any abrasion of the polymer materials in contact with it.

As shown in FIG. 5, the quartz pressing element (24) may have a shape designed to optimise the quality of the weld.

More precisely, the lower side (25) of the quartz element comprises two plane zones (26, 27) connected by an offset (28). These two parallel plane zones (26, 27) are designed to come into contact with two distinct regions of the bonding zone (18). More precisely, the first part (26), of greater width, is in contact with the bonding zone (18) having the highest thickness, combining the thickness of the two layers of coated textile (3, 13) and the bonding strip (1).

The second, more prominent zone (27) comes into contact only with the lower coated textile sheet (13). The inclined offset (28) defines, as shown in FIG. 6, a clearance zone inside which the non-cross-linked silicone can flow when subjected to a sufficient pressure.

Thus, after the positioning of the pressing and heating element (24) as shown in FIG. 6, the emitter (20) is then powered while a pressure is applied by the pressing element (24) at the bonding zone (18).

The radiation thus emitted causes the chemical reaction making the non-cross-linked silicone of the bonding strip (1) adhere to the silicone coating layers of the coated textile sheets (3, 13). The temperature reached at the core of the characteristic strip (1) is about 300° C. during the infrared radiation emission phases, and the pressure applied to the stack of layers is about 5 bar.

After cooling and as shown in FIG. 7, the silicone of the bonding strip (1) has at least partially cross-linked, and is therefore extended along the selvedge (30) of the coated textile sheet (3, 13).

This silicone then blocks the selvedge (30) of coated textile, thereby causing a certain sealing of this zone (18).

In the form shown, the coated textile sheets (3, 13) are pressed between the pressing element (24) and the table (9), and more precisely a reflecting element (29) integral with the table (9). This reflecting element (29) reflects part of the radiation which has passed through the two layers of coated textile (3, 13) to optimize the energy transfer.

However, in alternative embodiments not shown, it is possible to install two heating and pressing elements, one on each side of the zone to be bonded.

It appears from the above that the invention allows for considerable progress in the field of the joining of textiles coated with a silicone based coat as it permits in particular the joining of two sheets without any deterioration in the chemical and mechanical properties thereof. This assembly method by short infrared radiation combined with quartz pressing offers numerous advantages over conventional methods of heating by conduction:
the heat transfer gradients are very high, because the thermal inertia is overcome on the materials partly transparent to IR, in the frequencies concerned,
the heating power per area obtainable is considerable (about 100 W/cm²),
power and short response times allow very rapid modulations of the baking profiles,
baking times are extremely short,
cooling times are also very short.

### INDUSTRIAL APPLICATIONS

Many industrial sectors are potentially concerned by the advantages of this method. The following can be mentioned, without the list being limitative:
assembly of technical textiles for textile architecture, solar protection, textile ceilings, sealing membranes,
assembly of airbags for the automotive industry,
assembly of silicone rods and ropes for the medical sector, etc.

1. Bonding intermediate (1) for coated textile sheets (3, 13) with a silicone based polymer coating, having the form of a strip including a non-cross-linked silicone elastomer fraction present on at least the external sides of the said strip, characterized in that it includes heat energy dissipating elements embedded in the non-cross-linked silicone elastomer mass.

2. Bonding intermediate (1) according to claim 1, characterized in that the heat energy dissipating elements absorb the radiation in the infrared spectrum.

3. Bonding intermediate (1) according to claim 1, characterized in that it has a plurality of parallel longitudinal grooves (2).

4. Bonding intermediate (1) according to claim 1, characterized in that it comprises a plurality of longitudinal reinforcing elements (7).

5. Bonding intermediate (31, 41) according to claim 4, characterized in that the longitudinal reinforcing elements are formed by previously cross-linked zones (33, 43) extending along the strip.

6. Method for bonding the textile sheet (3, 13) coated with a silicon based polymer coat (5), characterized in that it consists in:
placing a strip (1) of a non-cross-linked silicone elastomer based material in the bonding zone (18);
applying a pressure at the said strip (1) while dissipating a heat energy during a predefined period.

7. Machine for bonding together two coated textile sheets (3, 13) having a silicone based polymer coating (5), characterized in that it comprises:
an assembly table (9) suitable for receiving the two textile sheets (3, 13) to be joined at a zone of superimposition of the edges of the said sheets;
at least one heating and pressing member (14), comprising:
an emitter (20) suitable for emitting radiation in the infrared spectrum;
a pressing element (24) transparent to the radiation in the infrared spectrum, and which has one side (25) suitable for coming into contact and for applying a pressure to the zone of superimposition of the two edges of the sheets (3, 13) to be bonded.

8. Machine according to claim 7, characterized in that the pressing element (24) is made of quartz.

9. Machine to according to claim 7, characterized in that it comprises two heating and pressing members placed on either side of the zone of superimposition of the two edges of the sheets.

10. Machine according to claim 7, characterized in that it comprises a device reflecting the infrared radiation, placed opposite the heating and pressing member (14), beyond the two sheets (3, 13) to be bonded.

11. Machine according to claim 7, characterized in that the heating and pressing member (14) extends longitudinally and parallel to the zone of superimposition of the edges of the two sheets (3, 13).

12. Machine according to claim 7, characterized in that the heating and pressing member (14) is mobile with respect to the table (9).

13. Machine according to claim 7, characterized in that the pressing element (24) has on its side (25) opposite the sheets (3, 13) to be bonded, a longitudinal offset (28) defining two substantially parallel and offset plane zones (26, 27).
